(19) United States
(12) Patent Application Publication
(10) Pub. No.: US 2018/0291579 A1
(43) Pub. Date: Oct. 11, 2018

(54) Snow/Ice Melting Drone Device

(71) Applicant: Shadecraft, Inc., Pasadena, CA (US)

(72) Inventor: Armen Sevada Gharabegian, Glendale, CA (US)

(21) Appl. No.: 15/888,034

(22) Filed: Feb. 4, 2018

Related U.S. Application Data
(60) Provisional application No. 62/454,772, filed on Feb. 4, 2017.

(51) Int. Cl. E01H 5/10; B64C 39/02

(52) U.S. Cl. CPC E01H 5/106; B64C 2201/146; B64C 2201/12; B64C 39/024

(57) ABSTRACT

An unmanned aerial vehicle (UAV) melting device, including an unmanned aerial vehicle (UAV), a melting apparatus to melt snow or ice in an area around the UAV melting device; and one or more connecting attachments to couple the UAV to the melting apparatus. The UAV melting device comprises a wireless transceiver, the wireless transceiver to receive operational commands from a user to determine direction of operation and area of coverage of the UAV melting device. The melting apparatus further comprises one or more power sources and one or more heating assemblies.

### RELATED APPLICATIONS

This application claims priority to U.S. provisional patent application Ser. No. 62/454,772, filed Feb. 4, 2017 and entitled “Snow/Ice Melting Drone Device,” the disclosure of which is hereby incorporated by reference

### BACKGROUND

### 1. Field

The subject matter disclosed herein relates to a drone or unmanned aerial vehicle (UAV) that melts snow and ice.

### 2. Information/Background of the Invention

Conventional snow melting devices require manual operation. Current snow melting devices require a user to hold and handle what is often a heavy device. This heavy device may cause stress on an operator's body especially an operator's joints (knees, elbows, shoulders, ankles). In addition, spreading salt, sand or other melting or gripping substances causes an operator to bend over and requires a good amount of exertion. Further, shoveling snow requires a large amount of exertion by an operator and is a leading cause of cardiac arrest and/or other coronary episodes.

Accordingly, alternative embodiments of ice and snow melting devices and apparatus may be desired.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1A illustrates a block diagram of a UAV snow melting apparatus according to an embodiment of an invention;

FIG. 1B illustrates another embodiment of a melting apparatus according to embodiments;

FIG. 2 illustrate a drone or UAV that is part of an ice/snow melting drone according to embodiments;

FIG. 3 illustrates a snow melting drone according to embodiments;

FIG. 4 illustrates an additional embodiment of a snow melting drown according to embodiments; and

FIG. 5 illustrates a modular umbrella shading system according to embodiments.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a problem, such as signal processing of signal samples, for example, may be allocated among computing devices, including one or more clients and/or one or more servers, via a computing and/or communications network, for example. A network may comprise two or more network devices and/or may couple network devices so that signal communications, such as in the form of signal packets and/or frames (e.g., comprising one or more signal samples), for example, may be exchanged, such as between a server and a client device and/or other types of devices, including between wireless devices coupled via a wireless network, for example.

A network may comprise two or more network and/or computing devices and/or may couple network and/or computing devices so that signal communications, such as in the form of signal packets, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals (e.g., signal samples), such as in memory as physical memory states, and/or may, for example, operate as a server in various embodiments.

Computing devices, mobile computing devices, and/or network devices capable of operating as a server, or otherwise, may include, as examples, rack-mounted servers, desktop computers, laptop computers, set top boxes, tablets, netbooks, smart phones, wearable devices, integrated devices combining two or more features of the foregoing devices, the like or any combination thereof. As mentioned, signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases, database servers, application data servers, proxy servers, and/or portions thereof, as appropriate.

It should be understood that for ease of description a network device may be embodied and/or described in terms of a computing device and/or mobile computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context. In a context of this application, if signals, instructions, and/or commands are transmitted from one component (e.g., a controller or processor) to another component (or assembly), it is understood that messages, signals, instructions, and/or commands may be transmitted directly to a component, or may pass through a number of other components on a way to a destination component. For example, a signal transmitted from a motor controller or processor to a motor (or other driving assembly) may pass through glue logic, an amplifier, an analog-to-digital converter, a digital-to-analog converter, another controller and/or processor, and/or an interface. Similarly, a signal communicated through a misting system may pass through an air conditioning and/or a heating module, and a signal communicated from any one or a number of sensors to a controller and/or processor may pass through a conditioning module, an analog-to-digital controller, and/or a comparison module, and/or a number of other electrical assemblies and/or components.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include for example, past, present and/or future mass storage, such as network attached storage (NAS), cloud storage, a storage area network (SAN), cloud storage, cloud server farms, and/or other forms of computing and/or device readable media, for example. A network may include a portion of the Internet, one or more local area networks (LANs), one or more wide area networks (WANs), wire-line type connections, one or more personal area networks (PANs), wireless type connections, one or more mesh networks, one or more cellular communication networks, other connections, or any combination thereof. Thus, a network may be worldwide in scope and/or extent.

The Internet and/or a global communications network may refer to a decentralized global network of interoperable networks that comply with the Internet Protocol (IP). It is noted that there are several versions of the Internet Protocol. Here, the term Internet Protocol, IP, and/or similar terms, is intended to refer to any version, now known and/or later developed of the Internet Protocol. The Internet may include local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices and/or computing devices may engage in an HTTP session through an exchange of appropriately compatible and/or compliant signal packets and/or frames. Here, the term Hypertext Transfer Protocol, HTTP, and/or similar terms is intended to refer to any version, now known and/or later developed. It is likewise noted that in various places in this document substitution of the term Internet with the term World Wide Web (‘Web’) may be made without a significant departure in meaning and may, therefore, not be inappropriate in that the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. A content delivery server and/or the Internet and/or the Web, therefore, in this context, may comprise an service that organizes stored content, such as, for example, text, images, video, etc., through the use of hypermedia, for example. A HyperText Markup Language (“HTML”), Cascading Style Sheets (“CSS”) or Extensible Markup Language (“XML”), for example, may be utilized to specify content and/or to specify a format for hypermedia type content, such as in the form of a file and/or an “electronic document,” such as a Web page, for example. HTML and/or XML are merely example languages provided as illustrations and intended to refer to any version, now known and/or developed at another time and claimed subject matter is not intended to be limited to examples provided as illustrations, of course.

Also as used herein, one or more parameters may be descriptive of a collection of signal samples, such as one or more electronic documents, and exist in the form of physical signals and/or physical states, such as memory states. For example, one or more parameters, such as referring to an electronic document comprising an image, may include parameters, such as 1) time of day at which an image was captured, latitude and longitude of an image capture device, such as a camera; 2) time and day of when a sensor reading (e.g., humidity, temperature, air quality, UV radiation) was received; and/or 3) operating conditions of one or more motors or other components or assemblies in a modular umbrella shading system. Claimed subject matter is intended to embrace meaningful, descriptive parameters in any format, so long as the one or more parameters comprise physical signals and/or states, which may include, as parameter examples, name of the collection of signals and/or states.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In embodiments, a modular umbrella shading system may comprise a computing device installed within or as part of a modular umbrella system, intelligent umbrella and/or intelligent shading charging system. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, numbers, numerals or the like, and that these are conventional labels. Unless specifically stated otherwise, it is appreciated that throughout this specification discussions utilizing terms such as “processing,” “computing,” “calculating,” “determining” or the like may refer to actions or processes of a specific apparatus, such as a special purpose computer or a similar special purpose electronic computing device (e.g., such as a shading object computing device). In the context of this specification, therefore, a special purpose computer or a similar special purpose electronic computing device (e.g., a modular umbrella computing device) is capable of manipulating or transforming signals (electronic and/or magnetic) in memories (or components thereof), other storage devices, transmission devices sound reproduction devices, and/or display devices.

In an embodiment, a controller and/or a processor typically performs a series of instructions resulting in data manipulation. In an embodiment, a microcontroller or microprocessor may be a compact microcomputer designed to govern the operation of embedded systems in electronic devices, e.g., an intelligent, automated shading object or umbrella, modular umbrella, and/or shading charging systems, and various other electronic and mechanical devices coupled thereto or installed thereon. Microcontrollers may include processors, microprocessors, and other electronic components. Controller may be a commercially available processor such as an Intel Pentium, Motorola PowerPC, SGI MIPS, Sun UltraSPARC, or Hewlett-Packard PA-RISC processor, but may be any type of application-specific and/or specifically designed processor or controller. In an embodiment, a processor and/or controller may be connected to other system elements, including one or more memory devices, by a bus, a mesh network or other mesh components. Usually, a processor or controller, may execute an operating system which may be, for example, a Windows-based operating system (Microsoft), a MAC OS System X operating system (Apple Computer), one of many Linux-based operating system distributions (e.g., an open source operating system) a Solaris operating system (Sun), a portable electronic device operating system (e.g., mobile phone operating systems), microcomputer operating systems, and/or a UNIX operating systems. Embodiments are not limited to any particular implementation and/or operating system.

The specification may refer to a modular umbrella shading system (or an intelligent shading object or an intelligent umbrella) as an apparatus that provides shade and/or coverage to a user from weather elements such as sun, wind, rain, and/or hail. In embodiments, the modular umbrella shading system may be an automated intelligent shading object, automated intelligent umbrella, and/or automated intelligent shading charging system. The modular umbrella shading system and/or automated shading object or umbrella may also be referred to as a parasol, intelligent umbrella, sun shade, outdoor shade furniture, sun screen, sun shelter, awning, sun cover, sun marquee, brolly and other similar names, which may all be utilized interchangeably in this application. These terms may be utilized interchangeably throughout the specification.

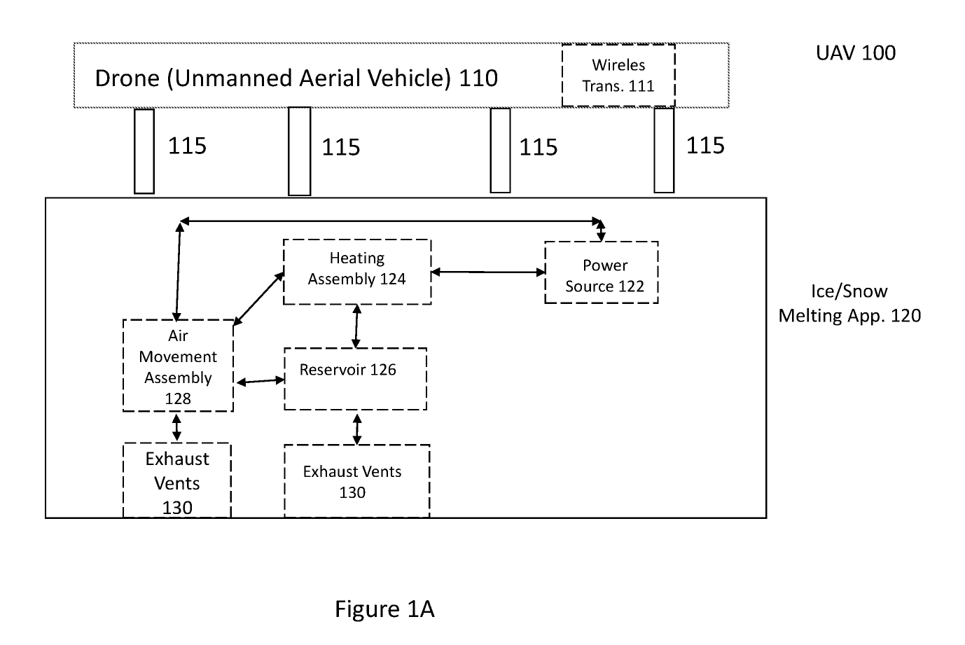

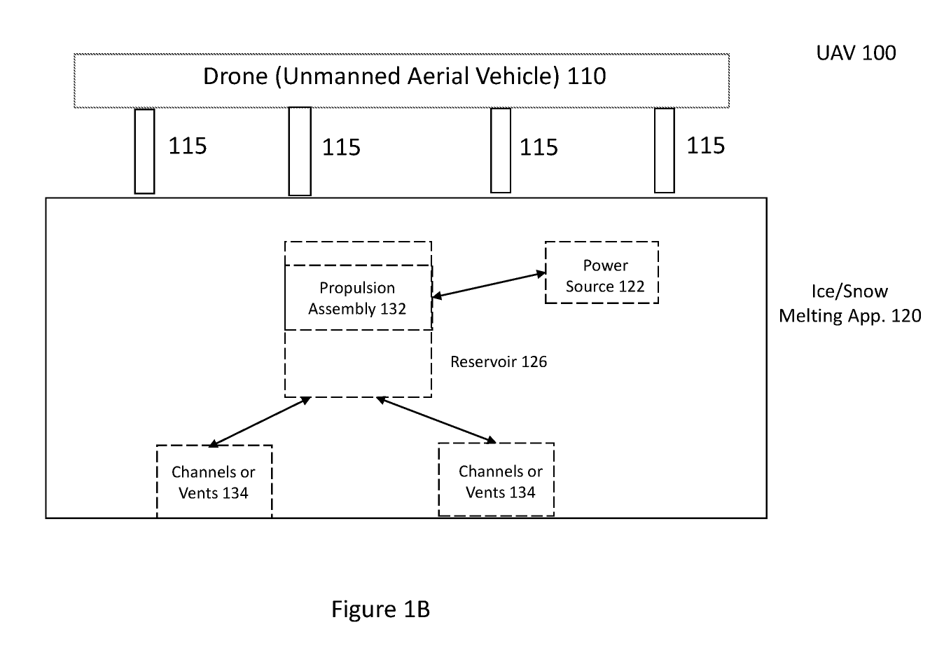

FIG. 1A illustrates a block diagram of a UAV snow melting apparatus according to an embodiment of an invention. In embodiments, the UAV snow melting device 100 comprises an unmanned aerial vehicle 110, one or more connecting runners or attachments 115 and a melting apparatus 120. In embodiments, one or more connecting runners or attachments 115 may connect, couple or attach an unmanned aerial vehicle 110 to a melting apparatus. In embodiments, as may be described in detail below, an operator may communicate commands to an unmanned aerial vehicle (or drone) 110 wirelessly to move the UAV snow melting device 100 in directions to cover an area from which snow and/or ice needs to be removed. In embodiments, a UAV 110 may comprise a wireless transceiver 111 to receive the commands from the operator. In embodiments, commands may be received from a wireless transceiver. In embodiments, a wireless transceiver 111 may also be located in a melting device or apparatus 120 or in connecting attachments 115.

In embodiments, a melting apparatus 120 may comprise one or more power sources 122, one or more heating assemblies 124, one or more reservoirs 126, one or more air movement assemblies 128 and/or one or more exhaust vents 130. In embodiments, a power source 122 may be a rechargeable battery or a replaceable battery. In embodiments, a power source 122 may provide power and/or a charge to a heating assembly 124. In embodiments, a heating assembly 124 may be a heating element, such as a heating coil. In embodiments, induction heating may be utilized by may heat a heating coil. In embodiments, induction heating may performed by disposing a workpiece to be heated within the induction coil and passing an alternating electric current through an induction coil. As an alternating electric current is passed through the induction con, the coil generates an electromagnetic field. Although an induction heating element is described, other heating elements may be utilized. In embodiments, a heating element may usually be a coil, ribbon (straight or corrugated), or strip of wire that gives off heat much like a lamp filament. In embodiments, when an electric current flows through a heating element, a heating element glows red hot and converts the electrical energy passing through a heating element into heat, which a heating element radiates out in all directions. In embodiments, eddy currents may be induced in the workpiece by an electromagnetic field that causes a workpiece to become heated. In embodiments, a reservoir 126 may hold a liquid substance, such as water, distilled water, saline, salt water, purified water. In embodiments, one or more heating elements 124 may heat up a liquid substance in one or ore reservoirs 126. In embodiments, steam or a heated gas may be generated. In embodiments, a power source may provide power to one or more movement assemblies 128. In embodiments, one or more air movement assemblies 128 may be an electric fan, an exhaust system, and/or a fan assembly. In embodiments, one or more air movement assemblies 128 may move or cause steam and/or heated air to move from a reservoir 126 through a first end of one or more exhaust vents or exhaust transport channel 130. In embodiments, steam and/or heated air may exit a UAV snow melting device 100 and specifically a second end of one or more exhaust vents or exhaust transport channels 130 of a snow melting apparatus 120. In embodiments, the steam and/or heated air may melt snow and/or ice on a surface below and/or under the UAV snow melting device 100. In embodiments, a UAV snow melting device 100 may be moved from place to place via commands, instructions, and messages communicated from a software application running on a mobile computing device, such as a laptop, a mobile telephone, a smart phone, a PDA, or other similar device; a remote control, a personal computer, and/or a network computer.

In embodiments, because the UAV snow melting device 100 is remote controlled, an operator may be able to remove snow and/or ice from an area (e.g., a sidewalk, a driveway, a porch, an entryway, and/or stairs) without a large amount of physical exertion and thus may not place the operator in a dangerous health state. In embodiments, an operator may be remote from an UAV snow melting device 100 (e.g., and potentially inside of a house or building) and operate a UAV snow melting device remotely. Accordingly, an operator may not be exposed to elements outside such as cold temperature and may clear snow and/or ice from a less dangerous setting.

FIG. 1B illustrates another embodiment of a melting apparatus according to embodiments. In embodiments, a melting apparatus 120 may comprise a power source 122, a reservoir 126, a substance propulsion assembly 132 and a substance transport channel or vent 134. In embodiments, a reservoir 126 may contain a material and/or substance that may melt snow and/or ice. In embodiments, a material and/or substance that melts ice and/or snow may be sand, salt, road salt, potassium chloride, rock salt, magnesium chloride, calcium chloride, ammonium sulfate, ammonium nitrate, and/or urea. In embodiments, depending on a corrosiveness of a substance, a reservoir 126 may need to have an interior surface lined with a specific type of plastic, ceramic and/or composite.

In embodiments, a power source 122 may be coupled to a substance propulsion assembly and provide power to a substance propulsion assembly 132. In embodiments, one or more reservoirs 126 may be coupled and/or connected to one or more substance transport channel or vents 134. In embodiments, one or more substance movement and/or propulsion assemblies 132 may propel and/or move a substance from one or more reservoirs 126 to one or more substance transport channels or vents 134. In embodiments, one or more substance movement and/or propulsion assemblies 132 may be a blade connected to a spring, where when a spring is expanded, a blade moves through one or more reservoirs 126 and moves a substance (e.g., salt) to one or more substance transport channels or vents 134 for depositing onto a surface that has ice and/or salt in order to melt the ice and/or salt. In embodiments, one or more reservoirs 126 may have an opening and/or door to allow a substance to be added to a snow/ice melting apparatus 120. In embodiments, one or more substance transport channels or vents 134 may have an interior surface coated with a ceramic, plastic, and/or composite depending on a corrosiveness of a substance being transported. In embodiments, a snow/ice melting apparatus 120 may be attached, coupled and/or connected to a UAV 110 via connectors, rods, and/or blades 115 in order for the snow/ice melting apparatus 120 to be moved from one position to another to clear and melt snow and/or ice.

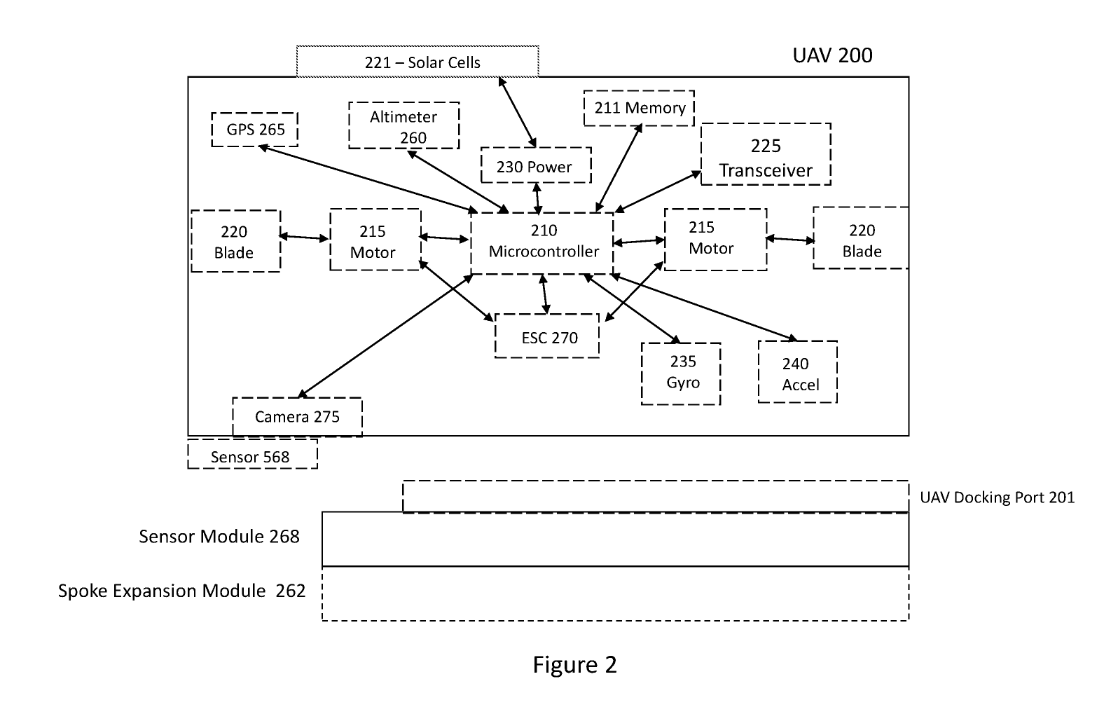

FIG. 2 illustrate a drone or UAV that is part of an ice/snow melting drone according to embodiments. In embodiments, a modular umbrella system 100 may also comprise a drone (or unmanned aerial vehicle (“UAV”)) system. In embodiments, a UAV system may comprise a UAV (e.g., drone) device 200 and/or a UAV docking port 201. In embodiments, a UAV system may depart from a UAV docking port 201 and fly around an area encompassing and/or surrounding a modular shading system. In embodiments, a UAV device 200 may have a range of 200 meters from a modular shading system. In embodiments, a mobile computing device may communicate with a drone utilizing personal area network protocols including but not limited to WiFi, Bluetooth, Zigbee, etc. In embodiments, computer-readable instructions stored in a memory of a computing device and executable by a processor of a computing device (e.g., SMARTSHADE and/or SHADECRAFT software) may control operations of a UAV device/drone 200. In embodiments, operations may include guiding movement of a drone, communicating measurements and/or data from a drone, activating/deactivating sensors on a drone, and/or activating/deactivating one or more cameras 275 on a drone. For example, in embodiments, a UAV device 200 may comprise one or more camera devices 275. In embodiments, a camera device 275 may capture images, video and/or sound of the environment surrounding a drone/UAV and may transmit and/or communicate images back to a computing device and/or other component of a modular umbrella shading system. In embodiments, for example, an air quality sensor may be installed on a UAV device, make take measurements during flight of the UAV device and may transmit and/or communicate captured measurements and/or readings from an air quality sensor to a sensor printed circuit board, and/or another component and/or assembly on a modular umbrella shading system. Placing sensors on a UAV device 200 may allow for more accurate and comprehensive sensor readings (e.g., measurements may be taken at a number of locations rather than only an exact locations at where a modular umbrella system is installed. In addition, more accurate and comprehensive sensor readings may be obtained at locations unreachable from a ground location (e.g., at higher elevations and/or at locations obscured and/or walled off from a place where an umbrella shading system is installed).

FIG. 2 illustrates a UAV that is part of an ice/snow melting apparatus and a docking device according to embodiments. In embodiments, a docking device may be located on a portion and/or surface of a modular umbrella shading system. In embodiments, a docking device or port 201 may be located on a flat, inclining surface, or a declining surface. In embodiments, a UAV docking port 201 may connect to a UAV device through a latching assembly, a mechanical coupling assembly, and/or through magnetic coupling. In embodiments, a UAV docking port 201 may provide power to a UAV device power source 230 (e.g., a rechargeable battery) through an electrical connection (e.g., wire or connector) and/or through wireless coupling (e.g., induction coupling). In embodiments, a UAV docking port 201 may be integrated into a sensor housing of a modular umbrella shading system. In embodiments, a UAV docking port 201 may be placed on a surface of a sensor housing of a modular umbrella shading system.

In embodiments, a drone may be referred to as an unmanned aerial vehicle (“UAV”). In embodiments, a UAV 200 comprises a frame, a microcontroller board 210, one or more rotors or motors 215, one or more propellers/blades 220, one or more wireless transceivers 225, and a power source 230. In embodiments, a UAV 200 may further comprise one or more gyroscopes 235 and/or one or more accelerometers 240. In embodiments, a UAV may comprise an altimeter 260. In embodiments, a UAV may comprise an electronic speed controller (ESC) 270. In embodiments, a UAV may comprise a GPS and/or GLONASS transceiver 265. In embodiments, a UAV may comprise one or more cameras 275.

In embodiments, a UAV 200 may be controlled by instructions transmitted by a computing device (e.g., a computing device in a mobile computing device and/or a computing device in a modular umbrella shading system). In embodiments, a computing device may be a mobile computing device having computer-readable instructions executed by a processor to interface and/or control a modular shading system and/or a UAV. In embodiments, a computing device may be a modular umbrella system computing device having computer-readable instructions stored thereon and executable by a processor. In embodiments, a modular umbrella shading system may comprise a user interface (e.g., on a display) that may control and/or interface to a UAV 200. In embodiments, a computing device may comprise a transceiver that communicates with one or more transceivers 225 in a UAV 200. In embodiments, a mobile computing device may communicate with a cloud-based server, which may communicate with one or more transceivers in a UAV 200.

In embodiments, a power source 230 may be a rechargeable battery. In embodiments, a rechargeable battery may allow for up to 12 hours of operation. In embodiments, a UAV 200 may comprise one or more solar panels or cells 221. In embodiments, one or more solar panels or cells 221 may convert sunlight into electricity which may be transferred to a rechargeable battery 230 in order to charge a rechargeable battery. In embodiments, a UAV may be powered via UAV docking port 201 on a modular shading umbrella system or other structure capable of providing DC and/or AC power.

In embodiments, a UAV 200 may comprise a microcontroller (e.g., a single board microcontroller) 210. In embodiments, a microcontroller 210 may include a processor, a memory, computer-readable instructions stored in the memory 211 and executable by the processor/microcontroller 210. In embodiments, a microcontroller 210 may control operations of one or more motors 215 of the UAV (and thus blades and/or propellers 220), may communicate and/or interface with inertial components such as gyroscopes 235 and/or accelerometers 240, may communicate and/or interface with landing sensors 268 and/or other sensors, may communicate and/or interface with cameras 275, and/or may communicate and/or interface with a power source 230 (e.g., rechargeable battery) and/or one or more solar cells or arrays 221. In embodiments, a single board microcontroller may be an Arduino board, a DJI A2 or other similar controllers. In embodiments, a UAV may also comprise an electronic speed controller (ESC) 270. In embodiments, an electronic speed controller 270 may be integrated into or on a same board as a microcontroller. In embodiments, a ESC 270 may determine and control speed, velocity and/or acceleration of a UAV by communicating messages, instructions, signals and/or commands to one or more motors 215 to tell motors how fast to operate and spin propeller blades 220. In embodiments, an ESC 270 may provide different speeds to different motors in order to move in specific directions.

In embodiments, an inertial measurement unit may comprise one or more gyroscopes 235 and/or one or more accelerometers 240. In embodiments, UAVs may be exposed to many external forces (wind, rain, physical objects, etc.) coming from different directions. In embodiments, external forces may impact a drone's yaw, pitch and/or roll, and thus impact a UAV's flight movement. In embodiments, one or more gyroscopes 235 detect such changes in position (e.g., changes in yaw, pitch and roll) and communicate this information to a microcontroller 210, which can then interface with an electronic speed control (ESC) 270, motors 215 and/or propellers/blades 220. In embodiments, gyroscopes feedback information on position hundreds of time each second. In embodiments, one or more accelerometers 240 may also measure changes in an UAV's orientation relative to an object's surface (e.g., Earth's surface). In embodiments, one or more accelerometers 240 communicate measurement changes in a UAV's orientation to a microcontroller 210, which in turn may communicate messages, commands and/or instructions to ESCs 270, which in turn may communicate messages, commands and/or instructions to motors 215 and/or propeller/blades 220.

In embodiments, a UAV may comprise an altimeter 260. In embodiments, an altimeter 260 may measure an altitude of a UAV and may communicate altitude measurements to a microcontroller 210. In embodiments, a microcontroller or controller or processor 210 may verify, compare and/or check altitude measurements against desired altitude measurements. In response to the verification and/or comparison, a microcontroller 210 may which in turn may communicate messages, commands and/or instructions to ESCs 270, which in turn may communicate messages, commands and/or instructions to motors 215 and/or propeller/blades 220.

In embodiments, a UAV 200 may comprise a GPS or GLONASS transceiver 265. In embodiments, a GPS transceiver 265 may capture and/or calculate position readings for a UAV 200 and communicate these measurement and/or calculated positions to a microcontroller 210. In embodiments, a microcontroller 210 may utilize GPS measurements and/or readings to determine a geographic location of a UAV. In embodiments, a microcontroller 210 may utilize GPS measurements to identify take off positions and/or landing positions. In embodiments, a GPS transceiver 265 may be located on a microcontroller 210. In embodiments, a GPS transceiver 265 may be located in an inertial measurement unit.

In embodiments, a UAV 200 may comprise landing sensors 268. In embodiments, landing sensors 268 may be light-based sensors and/or ultrasonic sensors. In embodiments, landing sensors 268 may be located on a bottom surface of a UAV 200 and/or a side surface of a UAV 200. In embodiments, landing sensors 268 may communicate measurements and/or readings regarding a landing surface (e.g., is a landing surface present, how far is it away (based on sound and/or light reflection)) to a microcontroller 210. In embodiments, a microcontroller 210 may communicate messages, commands and/or instructions to ESCs 270, which in turn may communicate messages, commands and/or instructions to motors 215 and/or propeller/blades 220 to move a UAV to a landing position (e.g., a modular umbrella system landing spot and/or landing dock).

In embodiments, a UAV 200 may comprise a landing system may comprise one or more wireless transceivers 225. In embodiments, a wireless transceiver 225 may communicate commands, instructions, signals and/or messages between wireless transceivers in other devices. In embodiments, a wireless transceiver 225 may communicate commands, instructions, signals and/or messages between wireless transceivers in a mobile computing device such as a smartphone, a tablet, a controller, a laptop computer etc. In embodiments, computer readable instructions, stored on a memory of a mobile computing device (and or modular umbrella system) may be executed on a processor (e.g., in a SMARTSHADE application) and one option in a software application may be UAV operation and/or control. In embodiments, for example, SMARTSHADE software application may comprise, among other things, a UAV or drone icon, which if selected, further presents various modes of UAV operation and control. In embodiments, a SMARTSHADE software application may provide instructions as to flight of a UAV, take off and/or landing of a UAV, movements in direction of a UAV, activation/deactivation of a UAV camera, and activation/deactivation of other sensors and/or components of a UAV. In embodiments, a SMARTSHADE application may communicate messages, instructions, commands and/or signals utilizing a wireless transceiver in a mobile computing device and a wireless transceiver in a UAV.

In embodiments, a UAV 200 may comprise one or more cameras 275. In embodiments, one or more cameras may be placed on a bottom surface and/or a side surface of a UAV 200 to capture images, sounds and/or videos of an area adjacent to and/or surrounding a modular umbrella system or other device to which a UAV device connected to a snow melting apparatus. In embodiments, a microcontroller 210 may activate and/or deactivate one or more cameras 275. In embodiments, one or more cameras 275 may capture images, sounds and/or videos and may communicate captured images, sounds and/or videos to a microcontroller 210, which may store captured images, sounds and/or videos in a memory of a UAV and/or a microcontroller 210. In embodiments, a microcontroller 210 may communicate and/or transfer captured images to a computing device in a modular umbrella system or other computing devices, which in turn may store captured images in a memory of a modular umbrella system and/or transfer captured images, video and/or sound to other computing devices (e.g., devices in a cloud) and/or mobile computing devices linked to a modular umbrella system (e.g., mobile computing devices utilizing and executing SMARTSHADE software). Likewise, other computing devices may be utilized as middle and/or intermediary computing devices and/or servers to transfer and/or communication sound, video or images to additional computing devices or servers. In embodiments, a UAV 200 may communicate captured images, video and/or sound via a wireless transceiver 225 to a mobile computing device (which utilizes its own wireless transceiver for communication). In other words, a UAV 200 may transfer and/or communicate images captured by its camera 275 directly to a mobile computing device or indirectly to a web server which in turn communicates the images, videos and/or sound to the mobile computing device (without passing through a modular umbrella system). In embodiments, a UAV 200 may land on or use a top of a modular umbrella system for a landing point or storage point. In embodiments, a UAV 200 may have its batteries charged by a modular umbrella system during rest and/or storage by solar cells on the modular umbrella system, a solar charging assembly and/or rechargeable batteries of the modular umbrella system.

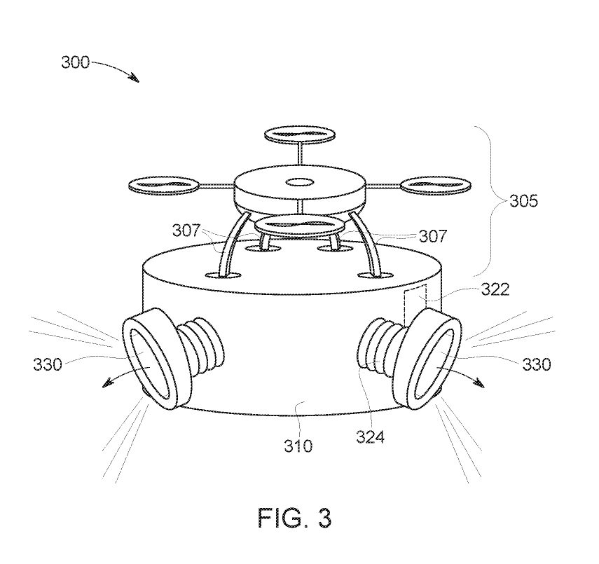

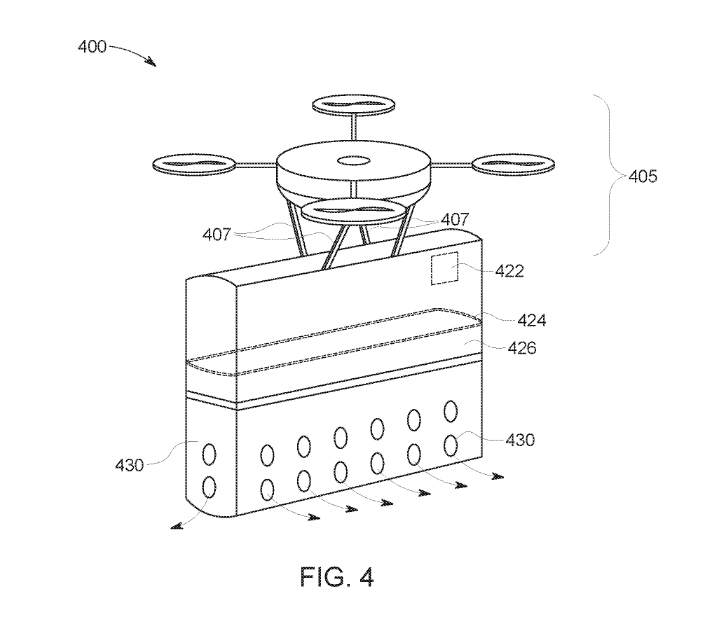

FIG. 3 illustrates a snow melting drone according to embodiments. In embodiments, an ice/snow melting drone 300 comprises a drone/UAV device 305, one or more attachments 307 and a snow/ice melting device 310. In embodiments, a snow/ice melting device 310 comprises batteries 322, heating elements 324 (e., coils like a blow dryer), and one or more exhaust vents 330. In embodiments, an operator may move an ice/snow melting drone through commands, instructions, and/or messages from a computing device. In embodiments, batteries 322 may power a heating coil 324, which causes a heating coil to heat up. In embodiments, a fan or other air movement assembly (not shown) may transfer heated air out of one or more exhaust vents 330, which are pointed in a downward direction or between a 10 to 90 degree direction from a direction parallel to a ground. In embodiments, heated air pushed out of the one or more exhaust vents melts snow or ice on a surface below an ice/snow melting drone. FIG. 4 illustrates an additional embodiment of a snow melting drown according to embodiments. In embodiments, an ice/snow melting drone 400 comprises a drone/UAV device 405, one or more attachments 407 and a snow/ice melting device 410. In embodiments, a snow/ice melting device 410 comprises batteries 422, a heater or heating elements 424 (e., coils like a blow dryer), and one or more exhaust vents 430. In embodiments, an operator may move an ice/snow melting drone through commands, instructions, and/or messages from a computing device. In embodiments, batteries 422 may power a heater 424, which causes a heater to heat up. In embodiments, a fan or other air movement assembly (not shown) may transfer heated air out of one or more exhaust vents 430, which are pointed in a downward direction to a surface. In embodiments, heated air pushed out of the one or more exhaust vents 430 melts snow or ice on a surface below an ice/snow melting drone. In embodiments, a snow melting device 410 may be made of stainless steel, other metals, a plastic, a ceramic or a composite. In embodiments, one or more exhaust vents 430 may be made of stainless steel, other metals, a plastic, a ceramic or a composite.

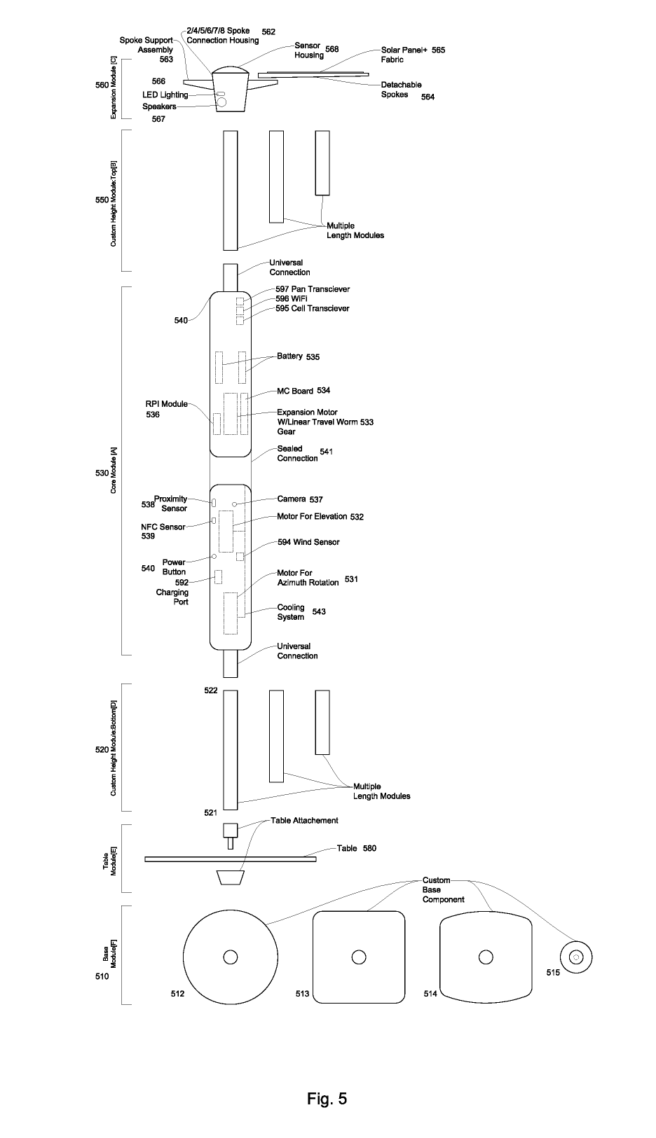

FIG. 5 illustrates a modular umbrella shading system according to embodiments. In embodiments, a modular umbrella system 500 comprises a base assembly or module 510, a first extension assembly or module 520, a core assembly module housing (or core umbrella assembly) 530, a second extension assembly or module 550, and an expansion sensor assembly or module (or an arm extension assembly or module) 560. In embodiments, a modular umbrella shading system 500 may not comprise a base assembly or module 510 and may comprise a table assembly or module 580 to connect to table tops, such as patio tables and/or other outdoor furniture. In embodiments, a table assembly or module 580 may comprise a table attachment and/or a table receptacle. In embodiments, a base module or assembly 510 may comprise a circular base component 512, a square or rectangular base component 513, a rounded edges base component 514, and/or a beach or sand base component 515. In embodiments, base components 512, 513, 514, and/or 515 may be interchangeable based upon a configuration required by an umbrella system and/or user. In embodiments, each of the different options for the base components 512, 513, 514, 515, and/or 580 may have a universal connector and/or receptacle to allow for easy interchangeability.

In embodiments, a first extension assembly or module 520 may comprise a shaft assembly having a first end 521 and a second end 522. In embodiments, a first end 521 may be detachably connectable and/or connected to a base assembly or module 510. In embodiments, a second end 522 may be detachably connected and/or connectable to a first end of a core umbrella assembly or module 530. In embodiments, a first end 521 and a second end 522 may have a universal umbrella connector. In other words, a connector may be universal within all modules and/or assemblies of a modular umbrella system to provide a benefit of allowing backwards capabilities with new versions of different modules and/or assemblies of a modular umbrella shading system. In embodiments, a first extension assembly or module 520 may have different lengths. In embodiments, different length first extension assemblies may allow a modular umbrella shading system to have different clearance heights between a base assembly or module 510 and/or a core umbrella assembly or module 530. In embodiments, a first extension assembly or module 510 may be a tube and/or a shell with channels, grooves and/or pathways for electrical wires and/or components and/or mechanical components. In embodiments, a first extension assembly 510 may be a shaft assembly having an inner core comprising channels, grooves and/or pathways for electrical wires, connectors and/or components and/or mechanical components.

In embodiments, a universal umbrella connector or connection assembly 524 may refer to a connection pair and/or connection assembly that may be uniform for all modules, components and/or assemblies of a modular umbrella system 500. In embodiments, having a universal umbrella connector or connection assembly 524 may allow interchangeability and/or backward compatibility of the various assemblies and/or modules of the modular umbrella system 500. In embodiments, for example, a diameter of all or most of universal connectors 524 utilized in a modular umbrella system may be the same. In embodiments, a universal connector or connection assembly 524 may be a twist-on connector. In embodiments, a universal connector 524 may be a drop in connector and/or a locking connector, having a male and female connector. In embodiments, a universal connector or connection assembly 524 may be a plug with another connector being a receptacle. In embodiments, universal connector 524 may be an interlocking plug receptacle combination. For example, universal connector 524 may be a plug and receptacle, jack and plug, flanges for connection, threaded plugs and threaded receptacles, snap fit connectors, adhesive or friction connectors. In embodiments, for example, universal connector or connection assembly 524 may be external connectors engaged with threaded internal connections, snap-fit connectors, push fit couplers. In embodiments, by having a universal connector or connection assembly 524 for joints or connections between a base module or assembly 510 and a first extension module or assembly 520, a first extension module or assembly 520 and a core assembly module or assembly 530, a core assembly module or assembly 530 and a second extension module or assembly 550, and/or a second extension module or assembly 550 and an expansion sensor module or assembly 560, an umbrella or shading object manufacturer may not need to provide additional parts for additional connectors for attaching, coupling or connecting different modules or assemblies of a modular umbrella shading system. In addition, modules and/or assemblies may be upgraded easily because one module and/or assembly may be switched out of a modular umbrella system without having to purchase or procure additional modules because of the interoperability and/or interchangeability.

In embodiments, a core umbrella assembly or module 530 may be positioned between a first extension assembly or module 520 and a second extension assembly or module 550. In embodiments, core umbrella assembly or module 530 may be positioned between a base assembly or module 510 and/or an expansion and sensor module or assembly 560. In embodiments, a core umbrella assembly or module 530 may comprise an upper core assembly 540, a core assembly connector or mid-section 541 and/or a lower core assembly 542. In embodiments, a core assembly connector 541 may be a sealer or sealed connection to protect a modular umbrella system from environmental conditions. In embodiments, a core umbrella assembly or module 530 may comprise two or more motors or motor assemblies. Although the specification may refer to a motor, a motor may be a motor assembly with a motor controller, a motor, a stator, a rotor and/or a drive/output shaft. In embodiments, a core umbrella assembly 130 may comprise an azimuth rotation motor 531, an elevation motor 532, and/or a spoke expansion/retraction motor 533. In embodiments, an azimuth rotation motor 531 may cause a core umbrella assembly 530 to rotate clockwise or counterclockwise about a base assembly or module 510 or a table connection assembly 580. In embodiments, an azimuth rotation motor 531 may cause a core umbrella assembly 530 to rotate about an azimuth axis. In embodiments, a core umbrella assembly or module 530 may rotate up to 360 degrees with respect to a base assembly or module 530.

In embodiments, an elevation motor 532 may cause an upper core assembly 540 to rotate with respect to a lower core assembly 542. In embodiments, an elevation motor 530 may rotate an upper core assembly 540 between 0 to 90 degrees with respect to the lower core assembly 542. In embodiments, an elevation motor 530 may rotate an upper module or assembly 540 between 0 to 30 degrees with respect to a lower assembly or module 542. In embodiments, an original position may be where an upper core assembly 540 is positioned in line and above the lower core assembly 542, as is illustrated in FIG. 1.

In embodiments, a spoke expansion motor 533 may be connected to an expansion and sensor assembly module 560 via a second extension assembly or module 550 and cause spoke or arm support assemblies in a spoke expansion sensor assembly module 560 to deploy or retract outward and/or upward from an expansion sensor assembly module 560. In embodiments, an expansion extension assembly module 560 may comprise a rack gear and spoke connector assemblies (or arms). In embodiments, a spoke expansion motor 533 may be coupled and/or connected to a hollow tube via a gearing assembly, and may cause a hollow tube to move up or down (e.g., in a vertical direction). In embodiments, a hollow tube may be connected and/or coupled to a rack gear, which may be connected and/or coupled to spoke connector assemblies. In embodiments, movement of a hollow tube in a vertical direction may cause spoke assemblies and/or arms to be deployed and/or retracted. In embodiments, spoke connector assemblies and/or arms may have a corresponding and/or associated gear at a vertical rack gear.

In embodiments, a core assembly or module 530 may comprise motor control circuitry 534 (e.g., a motion control board 534) that controls operation of an azimuth motor 531, an elevation motor 532 and/or an expansion motor 533, along with other components and/or assemblies. In embodiments, the core assembly module 530 may comprise one or more batteries 535 (e.g., rechargeable batteries) for providing power to electrical and mechanical components in the modular umbrella system 500. For example, one or more batteries 535 may provide power to motion control circuitry 534, an azimuth motor 531, an expansion motor 533, an elevation motor 532, a camera 537, a proximity sensor 538, a near field communication (NFC) sensor 538. In embodiments, one or more batteries 535 may provide power to an integrated computing device 536, although in other embodiments, an integrated computing device 536 may also comprise its own battery (e.g., rechargeable battery).

In embodiments, the core assembly 530 may comprise a separate and/or integrated computing device 536. In embodiments, a separate computing device 536 may comprise a Raspberry Pi computing device, other single-board computers and/or single-board computing device. Because a modular umbrella shading system has a limited amount of space, a single-board computing device is a solution that allows for increased functionality without taking up too much space in an interior of a modular umbrella shading system. In embodiments, a separate computing device 536 may handle video, audio and/or image editing, processing, and/or storage for a modular umbrella shading system 500 (which are more data intensive functions and thus require more processing bandwidth and/or power). In embodiments, an upper core assembly 540 may comprise one or more rechargeable batteries 535, a motion control board (or motion control circuitry) 534, a spoke expansion motor 533 and/or a separate and/or integrated computing device 536.

In embodiments, a core assembly connector/cover 541 may cover and/or secure a connector between an upper core assembly 540 and a lower core assembly 542. In embodiments, a core assembly connector and/or cover 541 may provide protection from water and/or other environmental conditions. In other words, a core assembly connector and/or cover 541 may make a core assembly 530 waterproof and/or water resistant and in other environments, may protect an interior of a core assembly from sunlight, cold or hot temperatures, humidity and/or smoke. In embodiments, a core assembly connector/cover 541 may be comprised of a rubber material, although a plastic and/or fiberglass material may be utilized. In embodiments, a core assembly connector/cover 541 may be comprised of a flexible material, silicone, and/or a membrane In embodiments, a core assembly connector/cover 541 may be circular and/or oval in shape and may have an opening in a middle to allow assemblies and/or components to pass freely through an interior of a core assembly connector or cover 541. In embodiments, a core assembly connector/cover 541 may adhere to an outside surface of an upper core assembly 540 and a lower core assembly 542. In embodiments, a core assembly connector/cover 541 may be connected, coupled, fastened and/or have a grip or to an outside surface of the upper core assembly 540 and the lower core assembly 542. In embodiments, a core assembly connector and/or cover 541 may be connected, coupled, adhered and/or fastened to a surface (e.g., top or bottom surface) of an upper core assembly and/or lower core assembly 542. In embodiments, a core assembly connector/cover 541 may cover a hinging assembly and/or reparation point, springs, and wires that are present between an upper core assembly 540 and/or a lower core assembly 542.

In embodiments, a core assembly or module 530 may comprise one or more cameras 537. In embodiments, one or more cameras 537 may be capture images, videos and/or sound of an area and/or environment surrounding a modular umbrella system 500. In embodiments, a lower core assembly 542 may comprise one or more cameras 537. In embodiments, a camera 537 may only capture sound if a user selects a sound capture mode on a modular umbrella system 500 (e.g., via a button and/or switch) or via a software application controlling operation of a modular umbrella system (e.g., a microphone or recording icon is selected in a modular umbrella system software application).

In embodiments, a core assembly 530 may comprise a power button to manually turn on or off power to components of a modular umbrella system. In embodiments, a core assembly or module 530 may comprise one or more proximity sensors 538. In embodiments, one or more proximity sensors 538 may detect whether or not an individual and/or subject may be within a known distance from a modular umbrella system 500. In embodiments, in response to a detection of proximity of an individual and/or subject, a proximity sensor 538 may communicate a signal, instruction, message and/or command to motion control circuitry (e.g., a motion control PCB 534) and/or a computing device 536 to activate and/or deactivate assemblies and components of a modular umbrella system 500. In embodiments, a lower core assembly 542 may comprise a proximity sensor 538 and a power button. For example, a proximity sensor 538 may detect whether an object is within proximity of a modular umbrella system and may communicate a message to a motion control PCB 534 to instruct an azimuth motor 531 to stop rotating a base assembly or module.

In embodiments, a core assembly or module 530 may comprise a near-field communication (NFC) sensor 539. In embodiments, a NFC sensor 539 may be utilized to identify authorized users of a modular umbrella shading system 500. In embodiments, for example, a user may have a mobile computing device with a NFC sensor which may communicate, pair and/or authenticate in combination with a modular umbrella system NFC sensor 539 to provide user identification information. In embodiments, a NFC sensor 539 may communicate and/or transmit a signal, message, command and/or instruction based on a user's identification information to computer-readable instructions resident within a computing device and/or other memory of a modular umbrella system to verify a user is authenticated and/or authorized to utilize a modular umbrella system 500.

In embodiments, a core assembly or module 530 may comprise a cooling system and/or heat dissipation system 543. In embodiments, a cooling system 543 may be one or more channels in an interior of a core assembly or module 530 that direct air flow from outside a modular umbrella system across components, motors, circuits and/or assembles inside a core assembly 530. For example, one or more channels and/or fins may be coupled and/or attached to components, motors and/or circuits, and air may flow through channels to fins and/or components, motors and/or circuits. In embodiments, a cooling system 543 may lower operating temperatures of components, motors, circuits and/or assemblies of a modular umbrella system 600. In embodiments, a cooling system 543 may also comprise one or more plates and/or fins attached to circuits, components and/or assemblies and also attached to channels to lower internal operating temperatures. In embodiments, a cooling system 543 may also move hot air from electrical and/or mechanical assemblies to outside a core assembly. In embodiments, a cooling system 543 may be fins attached to or vents in a body of a core assembly 530. In embodiments, fins and/or vents of a cooling system 543 may dissipate heat from electrical and mechanical components and/or assemblies of the core module or assembly 530.

In embodiments, a separate, detachable and/or connectable skin may be attached, coupled, adhered and/or connected to a core module assembly 530. In embodiments, a detachable and/or connectable skin may provide additional protection for a core assembly module against water, smoke, wind and/or other environmental conditions and/or factors. In embodiments, a skin may adhere to an outer surface of a core assembly. 530. In embodiments, a skin may have a connector on an inside surface of the skin and core assembly 530 may have a mating receptacle on an outside surface. In embodiments, a skin may magnetically couple to a core assembly 530. In embodiments, a skin may be detachable and removable from a core assembly so that a skin may be changed for different environmental conditions and/or factors. In embodiments, a skin may connect to an entire core assembly. In embodiments, a skin may connect to portions of an upper core assembly 540 and/or a lower core assembly 542. In embodiments, a skin may not connect to a middle portion of a core assembly 530 (or a core assembly cover connector 541). In embodiments, a skin may be made of a flexible material to allow for bending of a modular umbrella system 500. In embodiments, a base assembly 510, a first extension assembly 520, a core module assembly 530, a second extension assembly 540 and/or an arm extension and sensor assembly 560 may also comprise one or more skin assemblies. In embodiments, a skin assembly may provide a cover for a majority of all of a surface area one or more of the base assembly, first extension assembly 520, core module assembly 530, second extension assembly 550 and/or arm extension sensor assembly 560. In embodiments, a core assembly module 530 may further comprise channels on an outside surface. In embodiments, a skin assembly may comprise two pieces. In embodiments, a skin assembly may comprise edges and/or ledges. In embodiments, edges and/or ledges of a skin assembly may be slid into channels of a core assembly module 530. In embodiments, a base assembly 510, a first extension assembly 520, a second extension assembly 540 and/or an arm expansion sensor assembly 560 may also comprise an outer skin assembly. In embodiments, skin assemblies for these assemblies may be uniform to present a common industrial design. In embodiments, skin assemblies may be different if such as a configuration is desired by a user. In embodiments, skin assemblies may be comprise of a plastic, a hard plastic, fiberglass, aluminum, other light metals (including aluminum), and/or composite materials including metals, plastic, wood. In embodiments, a core assembly module 530, a first extension assembly 520, a second extension assembly 550, an arm expansion sensor assembly 560, and/or a base assembly 510 may be comprised of aluminum, light metals, plastic, hard plastics, foam materials, and/or composite materials including metals, plastic, wood. In embodiments, a skin assembly may be provide protection from environmental conditions (such as sun, rain, and/or wind).

In embodiments, a second extension assembly 550 connects and/or couples a core assembly module 530 to an expansion assembly sensor module (and/or arm extension assembly module) 560. In embodiments, an expansion sensor assembly module 560 may have universal connectors and/or receptacles on both ends to connect or couple to universal receptacles and/or connectors, on the core assembly 530 and/or expansion sensor assembly module 560. FIG. 1 illustrates that a second extension assembly or module 550 may have three lengths. In embodiments, a second extension assembly 550 may have one of a plurality of lengths depending on how much clearance a user and/or owner may like to have between a core assembly module 530 and spokes of an expansion sensor assembly or module 560. In embodiments, a second extension assembly or module 550 may comprise a hollow tube and/or channels for wires and/or other components that pass through the second extension assembly or module 550. In embodiments, a hollow tube 549 may be coupled, connected and/or fixed to a nut that is connected to, for example, a threaded rod (which is part of an expansion motor assembly). In embodiments, a hollow tube 549 may be moved up and down based on movement of the threaded rod. In embodiments, a hollow tube in a second extension assembly may be replaced by a shaft and/or rod assembly.

In embodiments, an expansion and sensor module 560 may be connected and/or coupled to a second extension assembly or module 550. In embodiments, an expansion and sensor assembly or module 560 may be connected and/or coupled to a second extension assembly or module 550 via a universal connector. In embodiments, an expansion and sensor assembly or module 560 may comprise an arm or spoke expansion sensor assembly 562 and a sensor assembly housing 568. In embodiments, an expansion and sensor assembly or module 560 may be connected to a hollow tube 549 and thus coupled to a threaded rod. In embodiments, when a hollow tube moves up and down, an arm or spoke expansion assembly 562 opens and/or retracts, which causes spokes/blades 564 of an arm extension assembly 563. In embodiments, arms, spokes and/or blades 564 may detachably connected to the arm or spoke support assemblies 563.

In embodiments, an expansion and sensor assembly module 560 may have a plurality of arms, spokes or blades 564 (which may be detachable or removable). Because the umbrella system is modular and/or adjustable to meet needs of user and/or environment, an arm or spoke expansion assembly 562 may not have a set number of arm, blade or spoke support assemblies 563. In embodiments, a user and/or owner may determine and/or configure a modular umbrella system 500 with a number or arms, spokes, or blades extensions 563 (and thus detachable spokes, arms and/or blades 564) necessary for a certain function and attach, couple and/or connect an expansion sensor assembly or module 560 with a spoke expansion assembly 562 with a desired number of blades, arms or spoke connections to a second extension module or assembly 550 and/or a core module assembly or housing 530. Prior umbrellas or shading systems utilize a set or established number of ribs and were not adjustable or configurable. In contrast, a modular umbrella system 500 described herein has an ability to have a detachable and adjustable expansion sensor module 562 comprising an adjustable number of arm/spoke/blade support assemblies or connections 563 (and therefore a flexible and adjustable number of arms/spokes/blades 564), which provides a user with multiple options in providing shade and/or protection. In embodiments, expansion and sensor expansion module 560 may be detachable or removable from a second extension module 550 and/or a core assembly module 530 and also one or more spokes, arms and/or assemblies 564 may be detachable or removable from arm or spoke support assemblies 563. Therefore, depending on the application or use, a user, operator and/or owner may detachably remove an expansion and sensor module or assembly 560 having a first number of arm/blade/spoke support assemblies 563 and replace it with a different expansion sensor module or assembly 560 having a different number of arm/blade/spoke support assemblies 563.

In embodiments, arms, blades and/or spokes 564 may be detachably connected and/or removable from one or more arm support assemblies 563. In embodiments, arms, blades, and/or spokes 564 may be snapped, adhered, coupled and/or connected to associated arm support assemblies 563. In embodiments, arms, blades and/or spokes 164 may be detached, attached and/or removed before deployment of the arm extension assemblies 563.

In embodiments, a shading fabric 565 may be connected, attached and/or adhered to one or more arm extension assemblies 563 and provide shade for an area surrounding, below and/or adjacent to a modular umbrella system 500. In embodiments, a shading fabric (or multiple shading fabrics) may be connected, attached, and/or adhered to one or more spokes, arms and/or blades 164. In embodiments, a shading fabric or covering 565 may have integrated therein, one or more solar panels and/or cells (not shown). In embodiments, solar panels and/or cells may generate electricity and convert the energy from a solar power source to electricity. In embodiments, solar panels may be coupled to a shading power charging system (not shown). In embodiments, one or more solar panels and/or cells may be positioned on top of a shading fabric 565. In embodiments, one or more solar panels and/or cells may be connected, adhered, positioned, attached on and/or placed on a shading fabric 565.

In embodiments, an expansion sensor assembly or module 160 may comprise one or more audio speakers 567. In embodiments, an expansion sensor assembly or module 560 may further comprise an audio/video transceiver. In embodiments, a core assembly 530 may comprise and/or house an audio/video transceiver (e.g., a Bluetooth or other PAN transceiver, such as Bluetooth transceiver 597). In embodiments, an expansion sensor assembly or module 560 may comprise an audio/video transceiver (e.g., a Bluetooth and/or PAN transceiver) In embodiments, an audio/video transceiver in an expansion sensor assembly or module 560 may receive audio signals from an audio/video transceiver 597 in a core assembly 530, convert to an electrical audio signal and reproduce the sound on one or more audio speakers 567, which projects sound in an outward and/or downward fashion from a modular umbrella system 500. In embodiments, one or more audio speakers 567 may be positioned and/or integrated around a circumference of an expansion sensor assembly or module 560.

In embodiments, an expansion sensor assembly or module 560 may comprise one or more LED lighting assemblies 566. In embodiments, one or more LED lighting assemblies 566 may comprise bulbs and/or LED lights and/or a light driver and/or ballast. In embodiments, an expansion sensor assembly or module 560 may comprise one or more LED lighting assemblies positioned around an outer surface of the expansion sensor assembly or module 560. In embodiments, one or more LED lighting assemblies 566 may drive one or more lights. In embodiments, a light driver may receive a signal from a controller or a processor in a modular umbrella system 500 to activate/deactivate LED lights. The LED lights may project light into an area surrounding a modular umbrella system 500. In embodiments, one or more lighting assemblies 566 may be recessed into an expansion or sensor module or assembly 560.

In embodiments, an arm expansion sensor housing or module 560 may also comprise a sensor housing 568. In embodiments, a sensor housing 168 may comprise one or more environmental sensors, one or more telemetry sensors, and/or a sensor housing cover. In embodiments, one or more environmental sensors may comprise one or more air quality sensors, one or more UV radiation sensors, one or more digital barometer sensors, one or more temperature sensors, one or more humidity sensors, and/or one or more wind speed sensors. In embodiments, one or more telemetry sensors may comprise a GPS/GNSS sensor and/or one or more digital compass sensors. In embodiments, a sensor housing 168 may also comprise one or more accelerometers and/or one or more gyroscopes. In embodiments, a sensor housing 568 may comprise sensor printed circuit boards and/or a sensor cover (which may or may not be transparent). In embodiments, a sensor printed circuit board may communicate with one or more environmental sensors and/or one or more telemetry sensors (e.g., receive measurements and/or raw data), process the measurements and/or raw data and communicate sensor measurements and/or data to a motion control printed circuit board (e.g., controller) and/or a computing device (e.g., controller and/or processor). In embodiments, a sensor housing 568 may be detachably connected to an arm connection housing/spoke connection housing to allow for different combinations of sensors to be utilized for different umbrellas. In embodiments, a sensor cover of a sensor housing 568 may be clear and/or transparent to allow for sensors to be protected from an environment around a modular umbrella system. In embodiments, a sensor cover may be moved and/or opened to allow for sensors (e.g., air quality sensors to obtain more accurate measurements and/or readings). In embodiments, a sensor printed circuit board may comprise environmental sensors, telemetry sensors, accelerometers, gyroscopes, processors, memory, and/or controllers in order to allow a sensor printed circuit board to receive measurements and/or readings from sensors, process received sensor measurements and/or readings, analyze sensor measurements and/or readings and/or communicate sensor measurements and/or readings to processors and/or controllers in a core assembly or module 530 of a modular umbrella system 500. In embodiments, a UAV snow melting device 100 may land and/or be positioned on an expansion and sensor module assembly 160. In embodiments, a UAV snow melting device 100 may land and/or be positioned on a ledge, shelf, and/or port that is attached, connected and/or coupled to a core assembly module 130, a base assembly module 110, a first extension module 120 and/or a second extension module 150.

A computing device may be a server, a computer, a laptop computer, a mobile computing device, a mobile communications device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

Internal architecture of a computing device includes one or more processors (also referred to herein as CPUs), which interface with at least one computer bus. Also interfacing with computer bus are persistent storage medium/media, network interface, memory, e.g., random access memory (RAM), run-time transient memory, read only memory (ROM), etc., media disk drive interface, an interface for a drive that can read and/or write to media including removable media such as floppy, CD-ROM, DVD, etc., media, display interface as interface for a monitor or other display device, keyboard interface as interface for a keyboard, mouse, trackball and/or pointing device, and other interfaces not shown individually, such as parallel and serial port interfaces, a universal serial bus (USB) interface, and the like.

Memory, in a computing device and/or a modular umbrella shading system, interfaces with computer bus so as to provide information stored in memory to processor during execution of software programs such as an operating system, application programs, device drivers, and software modules that comprise program code or logic, and/or computer-executable process steps, incorporating functionality described herein, e.g., one or more of process flows described herein. CPU first loads computer-executable process steps or logic from storage, storage medium/media, removable media drive, and/or other storage device. CPU can then execute the stored process steps in order to execute the loaded computer-executable process steps. Stored data, e.g., data stored by a storage device, can be accessed by CPU during the execution of computer-executable process steps.

Non-volatile storage medium/media is a computer readable storage medium(s) that can be used to store software and data, e.g., an operating system and one or more application programs, in a computing device or storage subsystem of an intelligent shading object. Persistent storage medium/media also be used to store device drivers, such as one or more of a digital camera driver, monitor driver, printer driver, scanner driver, or other device drivers, web pages, content files, metadata, playlists and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in an intelligent shading controller may include or may execute a variety of possible applications, such as a software applications enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A computing device or a processor or controller in an intelligent shading object may also include or execute an application to communicate content, such as, for example, textual content, multimedia content, or the like. A computing device or a processor or controller in an intelligent shading object may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in an intelligent shading object may also include imaging software applications for capturing, processing, modifying and transmitting image files utilizing the optical device (e.g., camera, scanner, optical reader) within a mobile computing device.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. For example, the server may be the server described in detail above. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. An unmanned aerial vehicle (UAV) melting device, comprising
an unmanned aerial vehicle (UAV);
a melting apparatus to melt snow or ice in an area around the UAV melting device; and
one or more connecting attachments to couple the UAV to the melting apparatus.

2. The UAV melting device of claim 1, further comprising a wireless transceiver, the wireless transceiver to receive operational commands from a user to determine direction of operation and area of coverage of the UAV melting device.

3. The UAV melting device of claim 1, the melting apparatus further comprising one or more power sources and one or more heating assemblies.

4. The UAV melting device of claim 3, the melting apparatus further comprising one or more reservoirs, the reservoirs including a liquid, wherein the one or more heating assemblies generate heat and provide the heat to the liquid in the reservoirs and to generate steam, the stem to melt snow or ice in the area around the UAV melting device.

5. The UAV melting device of claim 4, further comprising one or more air movement assemblies and one or more channels, the power source to provide power to the air movement assemblies, the air movement assemblies to generate an air flow to cause the steam generated from the liquid in the reservoir to move through the one or more channels and to melt the snow or ice in the area around the UAV melting device.

6. An unmanned aerial vehicle (UAV) melting device, comprising
an unmanned aerial vehicle (UAV);
a melting apparatus to melt snow or ice in an area around the UAV melting device;
a power source to provide power to the melting apparatus; and
one or more connecting attachments to couple the UAV to the melting apparatus.

7. The UAV melting device of claim 6, further comprising:
a reservoir, the reservoir holding a liquid substance, the liquid substance to assist the melting apparatus in melting the snow or ice.

8. The UAV melting device of claim 7, further comprising a substance propulsion assembly and a substance transport channel, the substance propulsion assembly to force liquid from the reservoir through the substance transport channel to the snow or ice to assist the melting apparatus in melting the snow or ice.

9. The UAV melting device of claim 8, wherein the propulsion device comprises a blade, the blade to push the substance through the reservoir to the substance transport channel.

10. The UAV melting device of claim 7, the reservoir including an inside surface coating, the inside surface coating to protect the reservoir from corrosive effects of the liquid substance.

11. The UAV melting device of claim 7, the reservoir including a door, the door utilized to load the liquid substance into the reservoir.
